(19) United States
(12) Patent Application Publication
(10) Pub. No.: US 2008/0245824 A1
(43) Pub. Date: Oct. 9, 2008

(54) Efficient fluidic spray and other delivery multipurpose asymmetrical or symmetrical systems

(76) Inventor: Annmarie Abu-Judom Lyles, Madison, WI (US)

Correspondence Address: Annmarie A. Lyles, 2 Sonora Court, Madison, WI, 53719, US

(21) Appl. No.: 11/732,210

(22) Filed: Apr. 3, 2007

(51) Int. Cl. B67D 5/60

(52) U.S. Cl. 222/377; 222/464.7

(57) ABSTRACT

Efficient fluidic trigger spray and push down delivery multipurpose asymmetrical or symmetrical systems are being described for delivering a multitude of chemical solutions such as any carpet, household, window, glass cleaner, degreasers, health and beauty products, some low viscosity fluids such as cooking sprays, and outdoor/indoor agricultural solutions just to name a few. Both symmetrical and asymmetrical delivery systems can be manufactured using any geometric shape and any base configuration. The efficiency arises from the fact that a protrusion chamber is created in one or more sides of the container and extending a flexible suction tube to communicate with the fluid contained in the protrusion chamber. Thus almost all of the fluid in the container will be delivered regardless of the position the container is operated. Hence, this invention provides means to deliver fluid from the container when the container is operated parallel to the floor, all the way to the upright position and continuing to the position parallel to the ceiling.

### BACKGROUND

1. Field of Invention

This invention generally relates to fluidic manually pumped, mostly for trigger, spray containers, metallic and non-metallic, refillable or disposable of any geometric shape and base configurations. More specifically, containers delivering spray of fine jet streams or any jets in between such as window, glass, carpet, and household cleaners, as well as auto spray chemical lubricants, chemicals to kill ants and weeds, starch sprays, stain removers, and non-stick oil sprays, just to name but a very few fluidic spray delivery systems.

2. Prior Art

Fluidic spray delivery systems, hand pumped, air pressurized and Freon pressurized do not deliver all the fluid contained therein especially when the container is tilted beyond a certain angle, generally beyond 45 to 75 degrees, leaving an amount generally between 3 and 20 percent of the original volume. In the worst case, a larger amount of fluid is lost (left over in the container) in pressurized containers regardless of the container's body or base geometrical shape.

In “Vertical Spray Bottle Nozzle”, Wright, 1992 Nov. 3, in U.S. Pat. No. 5,160,071 disclosed a container that is inefficient in the sense that an appreciable volume will still remain at the bottom of the container. Similarly, Rhea, 1993 Mar. 23, U.S. Pat. No. 5,195,664 will still have an appreciable volume at the bottom of his container. Lastly Ouellette, 2006 Jun. 6, U.S. Pat. No. 7,055,722 B2, disclosed a rather horizontal position spray bottle, but with a relatively large volume remaining in the asymmetric portion of the container.

### SUMMARY

The present invention is about efficient fluidic spray and other delivery multipurpose asymmetrical or symmetrical systems for a multitude of fluidic solutions and some very low viscosity fluids such as vegetable oil used in non-stick sprays. The inefficiency referred to in the prior art is circumvented by creating a protrusion or small chamber at the base of the container to any side or sides and extending the flexible suction tube to meet the chamber or protrusion's outside wall created within the container.

### DRAWINGS—FIGURES

FIGS. 1A to 1C show asymmetric spray embodiments.

FIG. 2 shows an asymmetric pump down delivery system.

FIGS. 3A and 3B show symmetric embodiments.

### DRAWINGS—REFERENCE NUMERALS

| | |
|---|---|
| 10. Trigger | 12. Pump |
| 14. Pump outlet | 16. Nozzle |
| 18. Suction tube | 20. Protrusion chamber |
| 22. Fluid | 24. Container |

### DETAILED DESCRIPTION

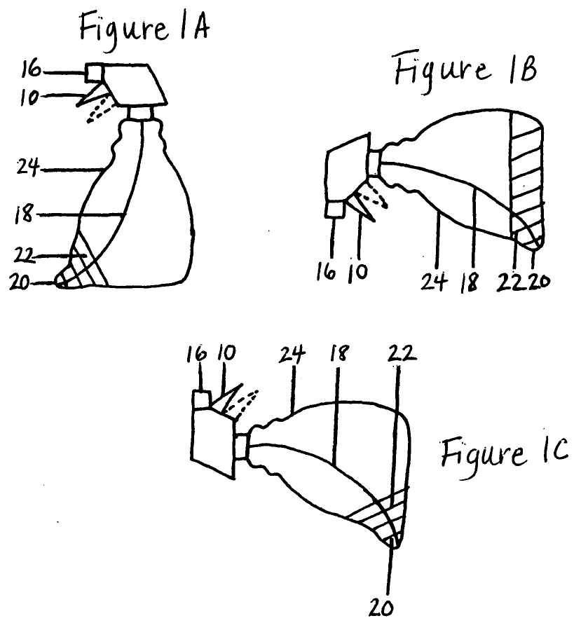

In FIGS. 1A, 1B and 1C, when trigger 10 is activated in a quadrant of a circle, a vacuum is created in container 24. Upon releasing trigger 10, fluid 22 is pumped up suction tube 18 from protrusion chamber 20 to spray through nozzle 16. As more and more fluid 20 is sprayed out of spray nozzle 14, more and more fluid 22 replaces fluid 22 in protrusion chamber 20 allowing suction tube 18 to always have fluid 22 to be sucked up until there is a minimal amount of fluid 22 left in protrusion chamber 20. Now when container 24 is tilted to 0 degrees to spray floors and the like as in FIG. 1B, the operation of pumping just described is enabled to continue until there is very minimal fluid 22 in container 24. In addition, beyond 90 degrees such as spraying ceilings of an automobile and the like, nozzle 16 and trigger 10 should be rotated 180 degrees as is shown in FIG. 1C, whereby nozzle 16 and trigger 10 is in the opposite direction of protrusion chamber 20. Hence, it can be seen how this embodiment of the invention can operate in the up-right, 90 degrees, as in FIG. 1A, but more importantly in the extreme tilted position, 0 degrees, as in FIG. 1B, and beyond 90 degrees, as in FIG. 1C, and anywhere in between these positions.

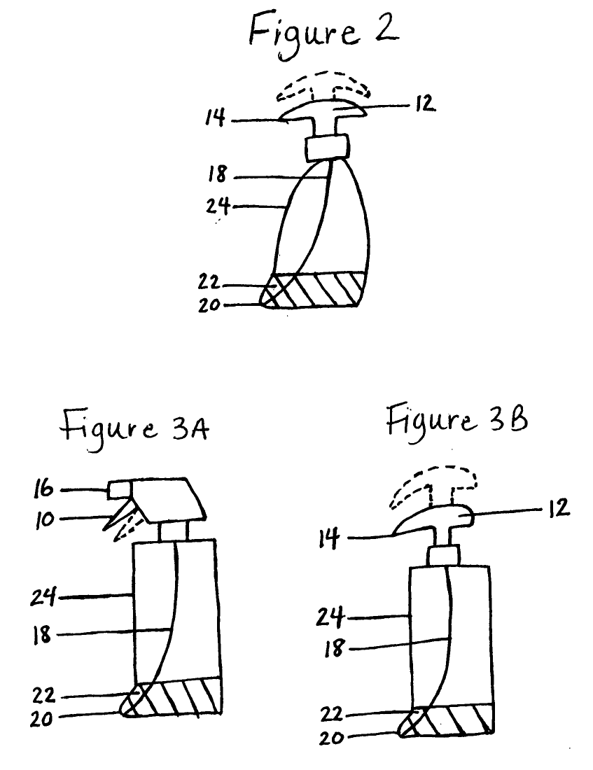

The description of operation of embodiments shown in FIG. 2 is identical for the trigger system described in FIG. 1A except that, in FIG. 2, pump 12 is activated by pushing down to create the vacuum. The fluid will be extracted from protrusion chamber 20 to pump outlet 14 via extended suction tube 18.

Again the novelty of this invention is retained via the creation of protrusion chamber 20 and extended suction tube 18; otherwise the operation of such symmetrical embodiments shown in FIGS. 3A and 3B are identical to those described in FIGS. 1A and 2.

### CONCLUSION

A description of efficient fluidic mostly for spray delivery and other multipurpose asymmetrical or symmetrical systems has been described with a detailed operation demonstrating the multipurpose system to spray fluid of low viscosity, such as any cleaning solution, indoor and/or outdoor ant, weed killer and the like, health and beauty products, non-stick oil spray, and auto degreaser, anywhere from when the system is in the upright position ranging to an extreme tilted position ranging from 0 degrees to beyond 90 degrees until the protrusion chamber and ultimately the container is almost empty. Also a push down pump such as in liquid soap, hair sprays or lotions and the like can be used with a container containing a protrusion chamber therein and a flexible extended suction tube. Even though the common geometric base, rounded corner, rectangular, almost elliptical has been fully described, it is becoming evident to those skilled in the art that other embodiments with a variety of bases such as circular, triangular, square, and multi-sided can be easily envisioned to achieve the identical purpose of efficient fluidic spray and other delivery multipurpose asymmetrical or symmetrical systems. The inventor is fully aware in the case that some harsh chemicals such as those used in the auto industry may require a different body material in which case a protrusion chamber will have to be created from the same material upon molding such containers. Also the inventor is aware as described previously that this invention can be used with disposable or refillable containers.

What is claimed is:

1. A fluidic dispenser comprising:
a) trigger spray dispensing means dispensing a fluid;
b) push down dispensing means dispensing a fluid;
c) liquid container means for holding liquid, said container means having a very minimal volume protrusion chamber molded within said fluid container;
d) a flexible extended suction tube depending from said dispensing means and in communication with said protrusion chamber;
e) free end of said flexible extended suction tube is in said protrusion chamber at all times.

2. A fluid dispenser as claimed in claim 1 having a trigger mechanism moving in a quadrant of a circle dispensing said fluid.

3. A fluid dispenser as claimed in claim 2, having a push down pumping motion dispensing said fluid.

4. A fluidic dispenser as claimed in claim 1 formed by blow molding or formed from the appropriate material to withstand chemical properties of said fluid.

5. An efficient fluidic delivery multipurpose system as claimed in claim 1 wherein said container is an asymmetrically shaped container of any geometric shape or base configurations.

6. An efficient fluidic delivery multipurpose system as claimed in claim 1 wherein said container is a symmetrically shaped container of any geometric shape or base configurations.
